(19) United States
(12) Patent Application Publication
(10) Pub. No.: US 2008/0302398 A1
(43) Pub. Date: Dec. 11, 2008

(54) Parts Washing Machine

(76) Inventor: Frank Raymond Jasper, Western Australia (AU)

Correspondence Address: GOTTLIEB RACKMAN & REISMAN PC, 270 MADISON AVENUE, 8TH FLOOR, NEW YORK, NY, 10016-0601, US

(21) Appl. No.: 11/573,122

(22) PCT Filed: Jun. 30, 2005
(86) PCT No.: PCT/AU2005/000962

§ 371 Date: Jun. 20, 2007

(30) Foreign Application Priority Data
Aug. 4, 2004 (AU) 2004203575
Aug. 4, 2004 (AU) 2004203576

(51) Int. Cl. B08B 3/02; F16D 49/00

(52) U.S. Cl. 134/112

(57) ABSTRACT

A parts washing machine comprising a housing defining washing chamber and having an opening associated with a closure which provides controlled access to the chamber through the opening, the chamber accommodating a basket adapted to support components to be cleaned, the basket being rotatable about a central upright axis, a drive associated with the basket to effect rotation of the basket, spray means adapted to direct a washing solution into the chamber, wherein the outer face of the side wall of the basket is generally smooth, a braking means adapted to engage the side wall of the basket to render the basket stationary.

### FIELD OF THE INVENTION

This invention relates to parts washers which are used in industry for the purposes of cleaning machine and motor parts prior to or during the servicing of machine motors etc.

Throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND

The parts washers of the form to which the invention relates generally comprise a housing having an opening at its upper face which is controlled by a closure. The interior of the housing defines a washing chamber which accommodates a basket intended to receive machine parts and the like and which is driven to rotate about its central axis within the housing. In addition the washing chamber is associated with suitably spray means intended to direct a washing solution on to the parts being carried by the basket. The drive can be effected by a drive motor or by the spray means or a jet of washing solution. For safety reasons, it is necessary that the basket be stationary and the spray and/or drive be de-activated before the closure is opened and while the closure is in the open position. A variety of braking mechanisms have been proposed to effect this braking action however due to the high masses involved and the harsh environment within the interior of the washing chamber many of these arrangements have failed.

### DISCLOSURE OF THE INVENTION

According to one aspect the invention resides in a parts washing machine comprising a housing defining washing chamber and having an opening associated with a closure which provides controlled access to the chamber through the opening, the chamber accommodating a basket adapted to support components to be cleaned, said basket being rotatable about a central upright axis, a drive associated with the basket to effect rotation of the basket, spray means adapted to direct a washing solution into the chamber, wherein at least a circumferential zone of the outer face of the side wall of the basket is generally smooth, a braking means adapted to be able to engage the zone of the side wall to render the basket stationary.

According to another aspect the invention resides in A parts washing machine comprising a housing defining washing chamber and having an opening associated with a closure which provides controlled access to the chamber through the opening, the chamber accommodating a basket adapted to support components to be cleaned, said basket being rotatable about a central upright axis, a drive associated with the basket to effect rotation of the basket, spray means adapted to direct a washing solution into the chamber, a braking means adapted to engage the basket to render the basket stationary, the braking means comprising a brake shoe supported from the housing and being mounted to be moveable into engagement with the side wall of the basket to frictionally engage the side wall.

According to a preferred feature of the invention the side wall is defined by a length of plate material curved to provide the side wall of the basket. According to a preferred feature of the invention the side wall comprises a substantially continuous band located around the lower portion of the side wall, the upper portion of the side wall being apertured. According to a preferred feature of the invention the side wall extends below the lower face of the floor of the basket.

According to a preferred feature of the invention the braking means engages the lower portion of the side wall.

According to a preferred feature of the invention the braking means engages the inner and outer face of the side wall

According to a preferred feature of the invention the braking means comprises a brake shoe supported from the housing and being mounted to be moveable into engagement with the side wall of the basket to frictionally engage the side wall. According to a preferred feature of the invention the shoe has an outer surface which is engageable with the side wall, said outer surface being formed of a material resistant to corrosion and substantially unreactive to the washing solution. According to a preferred feature of the invention the material comprises a material relatively softer than the material forming the side wall of the basket, said material being relatively malleable or ductile. According to a preferred feature of the invention the material comprises a plastics material. According to an alternative preferred feature of the invention the material comprises a metal or metal alloy. According to a preferred feature of the invention the metal is selected from brass, bronze or a like metal alloy.

According to a preferred feature of the invention the outer surface of the brake shoe is defined by a pad which is removably mounted to the brake shoe. According to a preferred feature of the invention the shoe has two ends and the outer surface has a curvature which is generally concentric with the central axis. According to a preferred feature of the invention the shoe is pivotally supported from a drive member which is driven to cause movement of the shoe out of engagement with the side wall. According to a preferred feature of the invention the ends of the shoe are each supported from a guide to enable radial movement of the shoe relative to the central axis but resist angular movement of the shoe relative to the central axis. According to a preferred feature of the invention each guide comprises a roller which supports the ends from the housing to permit the radial movement.

The invention will be more fully understood in the light of the following description of several specific embodiments.

### BRIEF DESCRIPTION OF THE DRAWINGS

The description is made with reference to the accompanying drawings of which:

FIG. 1 is a generally plan view of the braking arrangement according to the first embodiment;

FIG. 2 is an isometric view of the rear face of a brake shoe according to the first embodiment and the drive member; and

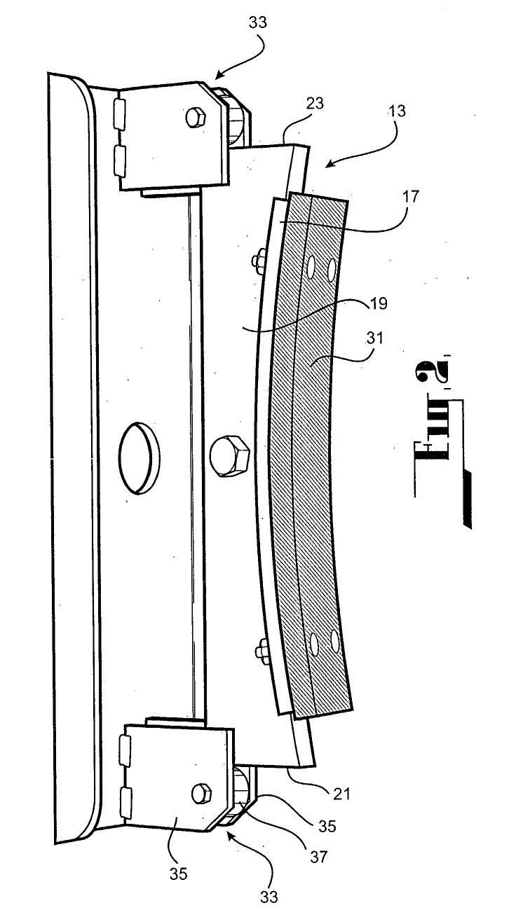

FIG. 3 is an isometric view of a basket according to the first embodiment.

### DETAILED DESCRIPTION OF SPECIFIC EMBODIMENTS

The first embodiment as shown in the accompanying drawings is directed to a parts washer which is used in workshops for the purposes of cleaning machine parts during the servicing of machines, engines, motors and the like.

Generally the washing machines to which the embodiment relates comprise a housing defining a washing chamber which has an open upper face and which is closed by a closure member which enables the chamber to be closed. The washing chamber supports a basket which has a generally cylindrical configuration defined by a generally planar base and cylindrical side wall 11. The basket is supported from the lower wall of the washing chamber through an upstanding shaft which is substantially central such that the basket is capable of rotating about its central upright axis. In addition the washing chamber accommodates spraying means which are intended to direct a washing solution onto the basket and the components contained on the basket. The basket is induced to rotate through the influence at least in part of the spraying means. The operation of the washing machine is controlled by a controller which will activate the drive motor, spraying means and a braking means as required.

For the purposes of worker safety it is a characteristic of such washing machines that before the closure can be opened the basket must be rendered stationary and/or the drive for the basket be de-activated or isolated from the basket.

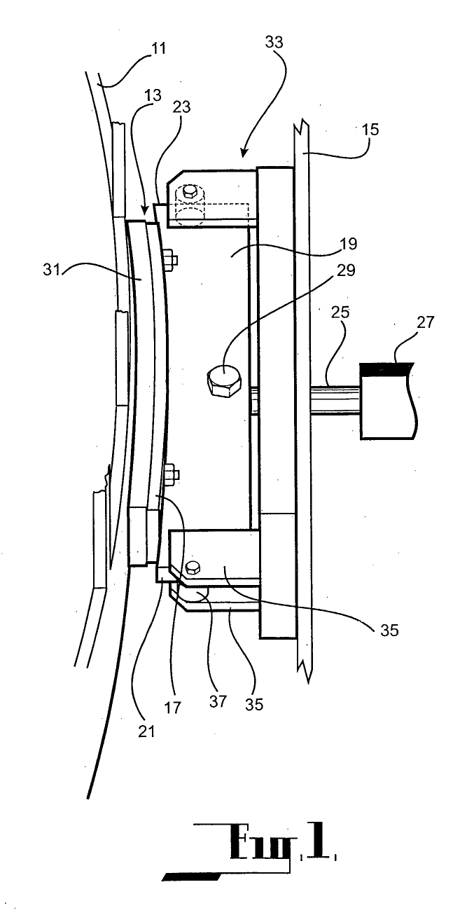

As shown at FIG. 1 the braking arrangement comprises a brake shoe 13 which is supported from the inner wall 15 of the housing and is positioned in opposed relation to a circumferential zone the outer face of the side wall 11 of the basket. The brake shoe 13 comprises a generally elongate brake pad support 17 which has an outer face which is generally concentric with the side wall 11 of the basket and which is supported upon a plate like support member 19 which is generally perpendicular to the brake pad support 17 and is provided with ends 21 and 23 which are generally radially disposed with respect to the central axis of the basket when the brake shoe is in position. The plate member 19 is intended to be pivotally supported at its the centre from the drive rod 25 of a fluid operated cylinder 27 by a pivot pin 29.

The brake pad support 17 supports a brake pad 31 which defines the outer braking face of the brake shoe. The brake pad 31 is formed of a brass or like metal alloy which is softer than the steel of which the side wall 11 of the basket 11 is formed. It is a desired characteristic of the metal which forms the brake pad that on being engaged by a protrusion or abrasive element when engaging the outer face of the circumferential zone of the side wall 11 it will score rather than shear or spall to avoid the production of shavings, chips and the like which can be damaging to the pump and other active elements of the washing machine. In addition the material of which the brake pad is formed is resistive to corrosive attack by the washing.

The brake shoe is further supported from the housing wall 15 by a pair of guides 33 which support each end 21 and 23 of the support member 19 to enable the support plate 19 to move radially with respect to the guides 33 and to prevent angular displacement of the shoe relative to the guides 33. Each of the guides 33 comprises a pair of parallel plate members 35 which support between themselves a roller 37 which is rotatably received between the plate members 35. The plate members 35 are spaced such that the support member 19 of the brake shoe is snugly and slidably received between the plate members while the roller member 37 is intended to engage the ends of the plate member to enable the radial movement of the plate member relative to the guides 33. As a result of the pivotal mounting of the brake shoe on the rod 25 of the cylinder 27 and the interaction between the guides 33 and the ends of the support member 19, the brake shoe is able to accommodate to variations in curvature of the outer perimeter of the basket 11 on rotation of the basket 11.

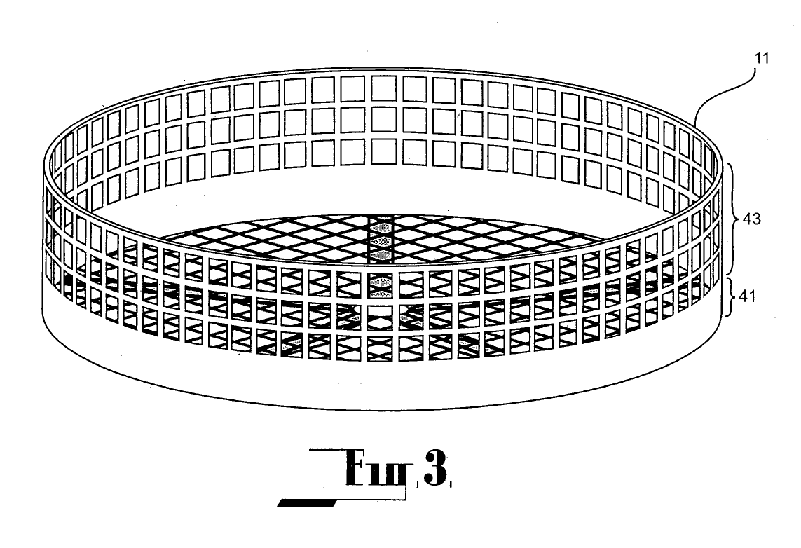

Furthermore, as shown at FIG. 3 the side wall 11 of the basket which is formed of a plate material which provides a relatively smooth and continuous outer surface. The side wall 11 is provided with a lower portion 41 which is continuous to define a band-like portion around the perimeter of the side wall and an upper portion which is aperture wherein the apertures can be formed by laser cutting or the like procedure. The lower portion defines the circumferential zone which is to be engaged by the brake shoe. In addition the apertures have a angular width which is less than the length of the outer face of the brake pad. In use the brake shoe is intended to engage with the lower portion 41 of the basket. However, if because of deformation of the basket or the like, the upper portion 43 of the wall becomes engaged with the brake shoe the fact that the length of the brake shoe is greater than the width of an aperture there will be no obstruction provided to the brake shoe by the presence of the apertures in the side wall and the braking action can still be applied to the basket albeit at a reduced level.

According to a second embodiment of the invention the upper portion of the basket is formed from a mesh material and the lower portion which defines the circumferential zone is formed of a band which extends axially from the upper portion.

It should be appreciated that the scope of the invention is not to be limited to the particular scope of the embodiments described above.

1. A parts washing machine comprising a housing defining a washing chamber and having an opening associated with a closure which provides controlled access to the chamber through the opening, the chamber accommodating a basket adapted to support components to be cleaned, said basket being rotatable about a central upright axis, a drive associated with the basket to effect rotation of the basket, spray means adapted to direct a washing solution into the chamber, wherein at least a circumferential zone of the outer face of the side wall of the basket is generally smooth, a braking means adapted to be able to engage the zone of the side wall to render the basket stationary, wherein the braking means comprises a brake shoe supported from the housing and being mounted to be moveable radially relative to the central axis into and out of engagement with the side wall of the basket to frictionally engage the side wall and wherein the shoe is supported from a guide to enable said radial movement of the shoe but to resist angular movement of the shoe relative to the central axis, the braking means further comprising a drive adapted to cause said radial movement of the brake shoe.

2. A parts washing machine as claimed at claim 1 wherein the side wall is defined by a length of plate material curved to provide the side wall of the basket.

3. A parts washing machine as claimed at claim 1 wherein the zone comprises a substantially continuous band located around the lower portion of the side wall, the upper portion of the side wall being apertured.

4. A parts washing machine as claimed at claim 1 wherein the side wall extends below the lower face of the floor of the basket.

5. A parts washing machine as claimed at claim 1 wherein the zone comprises the lower portion of the side wall.

6. A parts washing machine as claimed at claim 1 wherein the braking means engages the outer face of the side wall.

7. (canceled)

8. A parts washing machine as claimed at claim 1 wherein the shoe has an outer surface which is engageable with the side wall, said outer surface being formed of a material resistant to corrosion and substantially unreactive to the washing solution.

9. A parts washing machine as claimed at claim 8 wherein the material comprises a material relatively softer than the material forming the zone of the side wall of the basket, said material being relatively malleable or ductile.

10. A parts washing machine as claimed at claim 8 wherein the material comprises a plastics material.

11. A parts washing machine as claimed at claim 8 wherein the material comprises a metal or metal alloy.

12. A parts washing machine as claimed at claim 11 wherein the metal is selected from brass, bronze or a like metal alloy.

13. A parts washing machine as claimed at claim 7 wherein the outer surface of the brake shoe is defined by a pad which is removably mounted to the brake shoe.

14. A parts washing machine as claimed at claim 7 wherein the shoe has two ends and the outer surface has a curvature which is generally concentric with the central axis.

15. A parts washing machine as claimed at claim 7 wherein the shoe is pivotally supported from a drive member which is driven from the drive to cause movement of the shoe out of engagement with the side wall.

16. A parts washing machine as claimed at claim 7 wherein the ends of the shoe are each supported from the guide to enable said radial movement.

17. A parts washing machine as claimed at claim 16 wherein each guide comprises a roller which supports the ends from the housing to permit the radial movement.

18. A parts washing machine as claimed at claim 1 wherein the drive member is connected to the shoe intermediate of the ends.

19. A parts washing machine as claimed at claim 18 wherein the drive member is connected to the shoe substantially mid-way between the ends.

20. A parts washing machine as claimed at claim 1 wherein the drive member comprises an extendable fluid operated element supported at one end from the housing and connected at the other end to the brake shoe.

21. A parts washing machine comprising a housing defining washing chamber and having an opening associated with a closure which provides controlled access to the chamber through the opening, the chamber accommodating a basket adapted to support components to be cleaned, said basket being rotatable about a central upright axis, a drive associated with the basket to effect rotation of the basket, spray means adapted to direct a washing solution into the chamber, a braking means adapted to engage the basket to render the basket stationary, the braking means comprising a brake shoe supported from the housing and being mounted to be moveable radially relative to the central axis into and out of engagement with the side wall of the basket to frictionally engage the side wall and wherein the shoe is supported from a guide to enable said radial movement of the shoe but to resist angular movement of the shoe relative to the central axis, the braking means further comprising a drive adapted to cause said radial movement of the brake shoe.

22. A parts washing machine as claimed at claim 21 wherein the shoe has an outer surface which is engageable with the side wall, said outer surface being formed of a material resistant to corrosion and substantially unreactive to the washing solution.

23. A parts washing machine as claimed at claim 22 wherein the material comprises a material relatively softer than the material forming the side wall of the basket, said material being relatively malleable or ductile.

24. A parts washing machine as claimed at claim 22 wherein the material comprises a plastics material.

25. A parts washing machine as claimed at claim 22 wherein the material comprises a metal or metal alloy.

26. A parts washing machine as claimed at claim 25 wherein the metal is selected from brass, bronze or a like metal alloy.

27. A parts washing machine as claimed at claim 21 wherein the outer surface of the brake shoe is defined by a pad which is removably mounted to the brake shoe.

28. A parts washing machine as claimed at claim 21 wherein the shoe has two ends and the outer surface has a curvature which is generally concentric with the central axis.

29. A parts washing machine as claimed at claim 21 wherein the ends of the shoe are each supported from a guide to enable said radial movement of the shoe.

30. A parts washing machine as claimed wherein each guide comprises a roller which supports the ends from the housing to permit the radial movement.

31. A parts washing machine as claimed at claim 21 wherein the shoe is pivotally supported from a drive member which is driven to by the drive to cause said movement of the shoe out of engagement with the side wall.

32. A parts washing machine as claimed at claim 21 wherein a circumferential zone of the side wall of the basket is generally smooth.

33. A parts washing machine as claimed at claim 32 wherein the side wall is defined by a length of plate material curved and interconnected at the ends to provide the side wall of the basket.

34. A parts washing machine as claimed at claim 32 wherein the side wall comprises a substantially continuous band located around the lower portion of the side wall, the upper portion of the side wall being apertured.

35. A parts washing machine as claimed at claim 21 wherein the drive member comprises an extendable fluid operated element supported at one end from the housing and connected at the other end to the brake shoe.

36. (canceled)
